(19) United States
(12) Patent Application Publication
(10) Pub. No.: US 2011/0076437 A1
(43) Pub. Date: Mar. 31, 2011

(54) Skateboard and method

(76) Inventor: Geoffrey A. McKee, San Carlos, CA (US)

(21) Appl. No.: 12/924,337

(22) Filed: Sep. 23, 2010

Related U.S. Application Data
(60) Provisional application No. 61/277,324, filed on Sep. 23, 2009.

(51) Int. Cl. B32B 3/04; B32B 37/00; B32B 38/04

(52) U.S. Cl. 428/68; 156/60; 156/256

(57) ABSTRACT

A method for producing a skateboard comprising providing a deck, and a skin foam sheet having a surface area greater than a surface area of the deck. The skin foam sheet is bonded to the deck such as to leave a residual portion of the skin foam sheet extending beyond the surface of the deck. The residual portion is subsequently bonded to the sides of the deck. A skateboard produced in accordance with the method.

### CROSS-REFERENCE TO RELATED APPLICATIONS

This application is a non-provisional patent application of provisional patent application, filed Sep. 23, 2009, and having Ser. No. 61/277,324. Benefit of the Sep. 23, 2009 date is hereby claimed.

### BACKGROUND OF THE INVENTION

1. Field of Invention

The present invention broadly relates in general to a skate board and method. More specifically embodiments of the present invention provide a skate board having a soft top for protecting and supporting a user's knees and further providing foot traction without an abrasive surface and dampening road vibration. More specifically further, embodiments of the present invention further relate to a method for producing skate board.

2. Description of the Background Art

A skateboard is typically a specially designed deck combined with a poly urethane coating used for making smoother grinds and stronger durability, used primarily for the activity of skateboarding. A skateboard is propelled by pushing with one foot while the other remains on top of the deck.

The deck may be constructed of any suitable material, such as plywood, fiberglass, bamboo, aluminum, or plastic. Conventional skateboard decks are typically slippery when wet and are not capable dampening or absorbing road and wheel vibration.

Thus, what is needed and what has been invented is a skateboard deck having a riding surface that provides traction (without an abrasive surface), increased foot cushioning and one which dampens (absorbs) road and wheel vibration. The skateboard deck of the present invention is safer/softer when impacted in close quarter conditions. What has also been invented is a method for manufacturing or producing skateboards having a cushioned deck.

### SUMMARY OF EMBODIMENTS OF THE INVENTION

Embodiments of the present invention provide a method for producing a skateboard comprising providing a deck for a skateboard, and a skin foam sheet having a surface area greater than a surface area of the deck. The skin foam sheet is bonded to the deck such as to leave a residual portion of the skin foam sheet extending beyond the surface of the deck. The residual portion is subsequently bonded to the sides of the deck. Embodiments of the invention further provide a skateboard produced in accordance with the method.

These provisions, together with the various ancillary provisions and features which will become apparent to those skilled in the art as the following description proceeds, are attained by the apparatuses and methods of the present invention, preferred embodiments thereof being shown with reference to the accompanying drawings, by way of example only, wherein:

### BRIEF DESCRIPTION OF THE DRAWINGS

FIG. 1 is a vertical sectional view of the skate board composite comprising a board [wood, plastic, or any other material], a foam cushion [optional] supported by the board, and a top skin wrapping around or enveloping a side edge of the board and having tapered ends secured to the bottom surface of the board.

FIG. 2 is an end elevational view of the upper half mold with a pair of depending lugs or tongue members having ends which initially engage a portion of the top surface of the sides or extremities of the top skin and displacing or pushing the top surface of the sides downwardly as the upper half of the mold is moved downwardly.

FIG. 3 is a side elevational view showing the skate board core supported by the bottom half of the mold and further showing the top skin disposed on top of the surface of the core and positioned for being engaged by the lugs or tongues upper half mold.

FIG. 4 is a side elevational view of the compression molding assembly of FIGS. 2 and 3 showing a side view of the skateboard core having the top skin disposed on the top thereof and positioned for having top skin sides for being displaced around the sides of the skateboard core.

FIG. 5 is an end elevational view of the top mold positioned for having its arcuate shaped lugs or tongues moved downwardly for tucking the top skin ends around the arcuate or curved ends of the skateboard core.

FIG. 6 is a horizontal view taken in direction of the arrows and long the plane of line 6-6 in FIG. 5.

FIG. 7 is a side elevational view of an embodiment of the skateboard illustrating the wood core, the bottom surface of the wood core, a sidewall or edge, an optional foam padding and a top skin member, which may be manufactured of foam.

FIG. 8 is a partial side elevational view illustrating the moving of the end of the skin member in direction of an arrow for securing the end to the bottom surface of the board.

FIG. 9 is a partial perspective view of a skateboard.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Embodiments of the present invention provide a foam skin hybrid construction skateboard, which is a multiple layer device consisting of an exterior foam surface (with or without interior laminated backer foam), co-molded around a multi-ply wood core or rigid plastic bottom, with soft foam edges. Embodiments of the present invention utilize anodized aluminum alloy skate trucks and cast poly urethane wheels, and have a foam-top non-edge wrapped geometry, permanently affixed to a rigid core. An elastomeric stretch skin, of sufficient thickness is provided to allow a contour form fit over a wood core. The elastomeric skin provides cushioning, traction and dampening effects. The elastomeric stretch skin can be either permanently affixed or a removable accessory piece. In one embodiment of the invention the end of the stretch top skin wraps around the side edges of the deck and secures to the bottom of the deck. The end may be tapered. In another embodiment the stretch top skin is secured to the sides of the skate board such that the end of the top skin registers with the bottom surface of the deck.

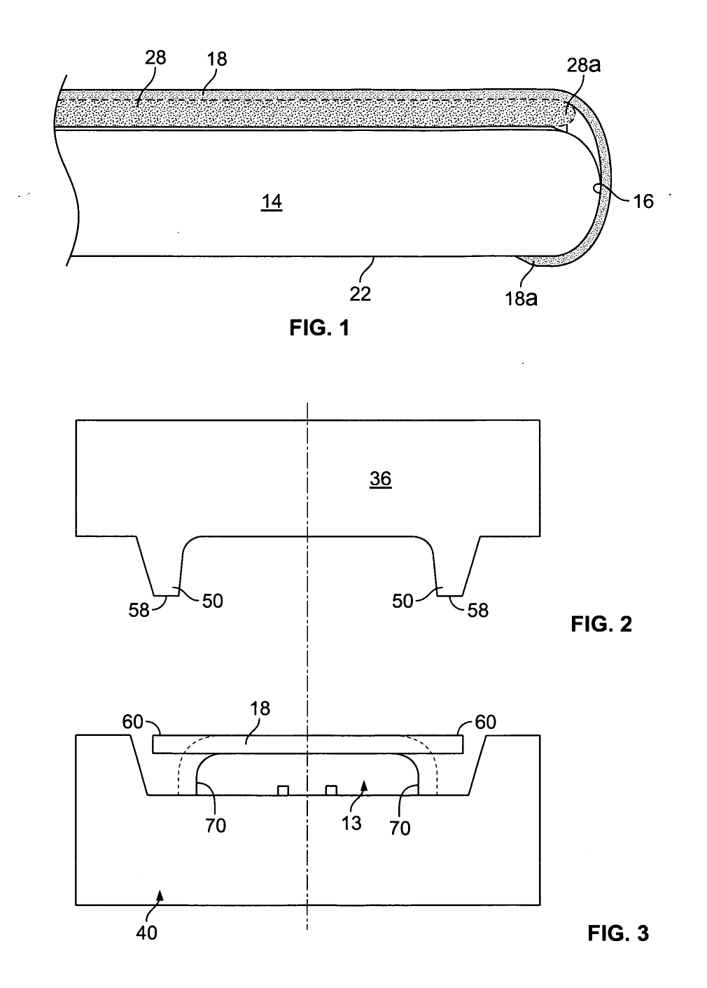

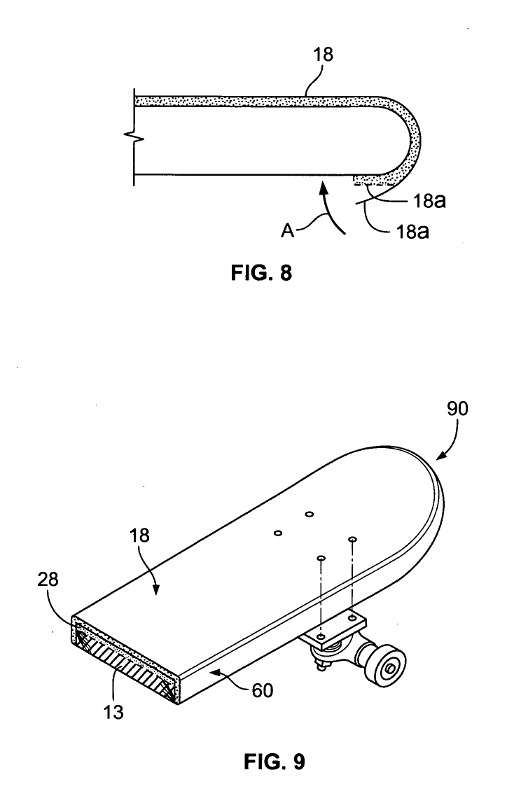

Referring in detail now to the drawings, there is seen in FIG. 1, a vertical sectional view through the skate board illustrating a board 14, skin wrap-around member 18 which wraps around the edge 16 of the board 14 and connects to the bottom surface 22 of the board 14. More specifically, the skin wrap-around member 18 has an end 18a, which may be tapered as shown in FIG. 1 that connects to the bottom surface 22 of the board 14. As shown in FIG. 8 securing the end 18a of the skin wrap-around member 18 to the bottom surface 22 of the board 14 may be accomplished by moving the end 18a of the skin member 18 in direction of an arrow A until the end 18a comes in contact with the bottom surface 22. The end 18a may be secured to the bottom surface 22 by any suitable means, such as with a bonding agent. Movement of the end 18a in direction of the arrow A may be done manually, or mechanically, such as by engaging and moving the end 18a with any suitable planar surface (e.g., a planar mold surface) after the skin wrap-around member 18 has been wrapped around the edge 16 and extends below the bottom surface 22 of the board 14. When the end 18a extends below the bottom surface 22 it is free to be moved. Thus, by moving the assembly of FIG. 8 downwardly such that the end 18a comes in contact with a planar surface, continual further movement of the assembly causes the end 18a to move in direction of the arrow A toward the bottom surface 22 until contacting and being secured to the same. Alternatively, a suitable planar surface may be moved toward the assembly of FIG. 8 to engage the end 18a and move the end 18a in direction of the arrow A until it is flushed against, and secured to, the bottom surface 22.

A foam member 28, which is optional, may be disposed between the skin wrap-around member 18 and the board 14. For this embodiment of the invention, the foam member 28 has an end 28a that terminates at the beginning of the edge 16. In FIG. 7 there is seen another embodiment of the invention where the end 28a of the foam member 28 terminates at the bottom of the edge 16 such that the end 28a registers with or is aligned with the bottom surface 22 of the board 14. As further shown in FIG. 7, respective ends 18a and 28a of the skin member 18 and the foam member 28 terminate at the bottom of the edge 16 such that both register with or are aligned with the bottom surface 22 of the board 14. For this embodiment of the invention, any portion of the skin wrap-around member 18 or the foam member 28 extending below the bottom surface 22 may be trimmed in order to cause the ends 18a and 28a to register with the bottom surface 22.

The skin 18 preferably comprises from about 25% by weight to about 80% by weight of the total composite sandwich or vertical cross section of the board composite 14, more preferably from about 20% by weight to about 70% by weight, most preferably from about 25% to about 60% by weight. The ratio of the skin thickness to the internal core (i.e., the board thickness) ranges from about 1:1 to about 1:16, more preferably from about 1:2 to about 1:14, most preferably from about 1:3 to about 1:10. The board surface or structure can possess any suitable geometric shape, such as concave or convex, with or without a kick tail configuration. The core of the skate board may be produced from any material, such as wood, plastic or any other suitable matter. Embodiments of the skateboard of the present invention may be manufactured by compression molding, adhesive bonding, roller lamination or lamination with internal backer.

In compression molding, the board 14 is placed within a rigid steel mold. A die cut foam sheet or skin 18, cut slightly oversize of the top deck of the board 14, is placed within the lower mold half, directly on top of the deck of the board 14. Typical foam materials can be EVA, PE, PU, or equivalent closed cell foam. The steel mold is closed and clamped shut. The foam skin 18 is compressed to the deck of the board 14 via heat and pressure. A bonding agent can be used as an accelerator between the wood and foam to expedite and/or strengthen the bond between the two unlike surfaces. After a nominal amount of time, the mold is opened and the composite sub-assembly is removed.

The remaining foam skin 18 (not bonded to the horizontal deck surface) is then wrapped around the edge 16 of the board 14. This secondary operation or procedure may be done manually or mechanically. When done manually, the skin 18 is formed and contoured by hand (i.e. wet gloved), glued and adhered to the board edge 16. It is then trimmed to size to remove excess flash. Alternatively, when done mechanically, the edge wrap process can be done with an additional rigid mold or fixture. In another embodiment, the foam member 28 may be placed on the deck first followed by the skin 18 and the bonding procedure is done simultaneously to bond the foam member 28 and the skin 18 to the deck. Alternatively further, the bonding procedure may be a two step process with the foam member 28 being secured first by heat and pressure, followed by the skin 18 being placed on top of the secured foam member 28 and bonded by heat and pressure.

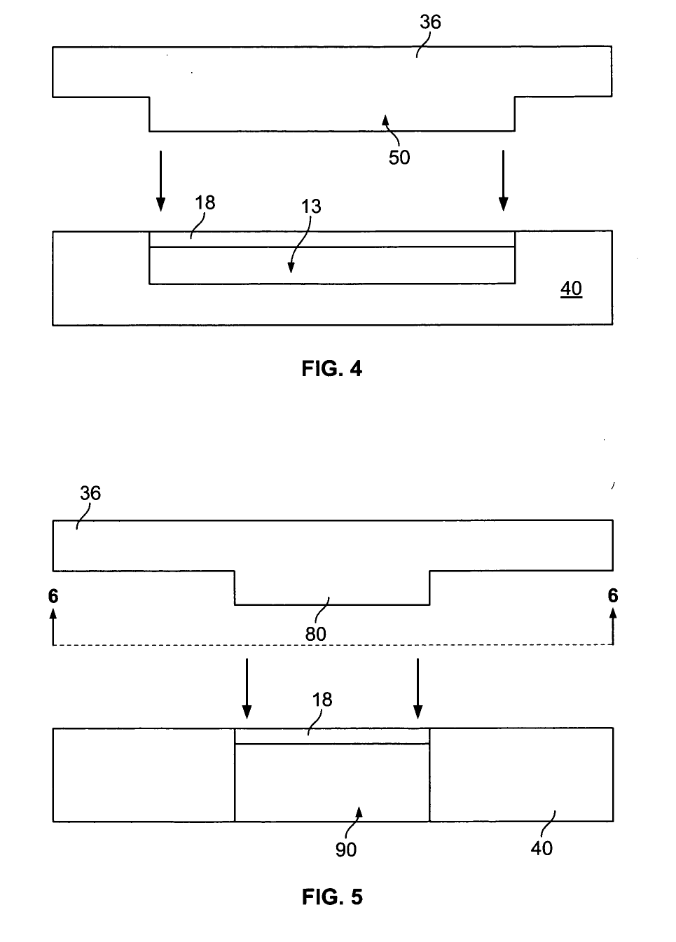

Referring now to Figures there is seen various views of embodiments for the compression molding procedure. FIGS. 4 and 5 is a perspective view of a pair of compression molds (i.e., top mold 36 and bottom mold 40) for producing an embodiment of the skate board 14. FIG. 2 is an end elevational view of the upper half mold 36 with a pair of parallel (straight) depending lugs or tongue members 50-50 having ends 58-58 which initially engage a portion (identified at 60-60) of the top surface of the sides or extremities of the top skin or wrap around member 18. When the top mold 36 is moved downwardly, ends 58-58 of the tongues or lugs 50-50 engage portions 60-60 of the skin 18 and then displace or push the top surface of the portions 60-60 toward the sides 70-70 of the core, as illustrated in FIG. 3. As previously indicated, the skin 18 may be compressed initially to the top of the deck by a mold not having depending lugs 50-50, followed by engaging portions 60-60 of the skin 18 to compress the same against the sides 70-70 (previously identified as edges 16-16). In another embodiment and as also previously indication, portions 60-60 may be secured to the sides 70-70 manually.

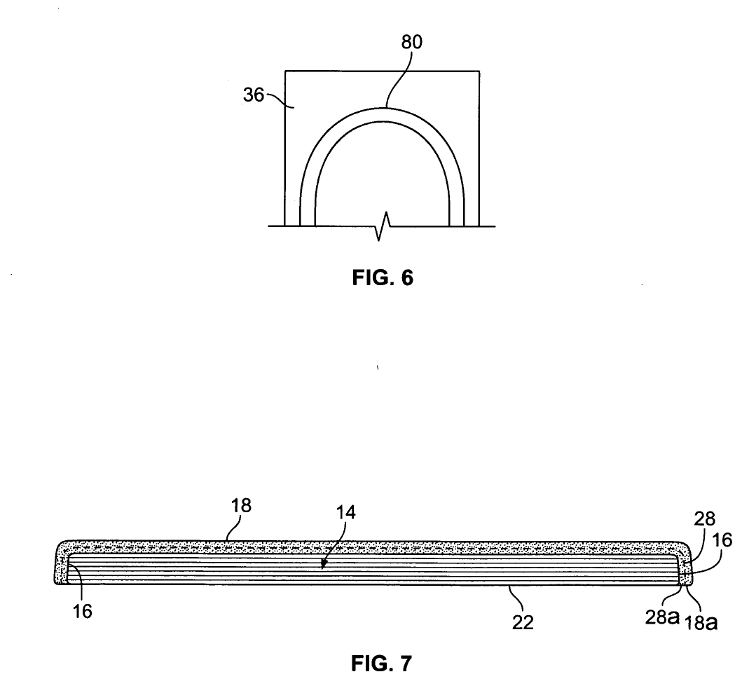

FIG. 4 is a side elevational view of the compression molding assembly of FIGS. 2-3 showing a side view of the skateboard core 13 having the top skin 18 disposed on the top thereof and positioned for having the top skin sides (e.g., portions 60-60) for being displaced around the sides 70-70 (edges 16-16) of the skateboard core 13. FIG. 5 is an end elevational view of the top mold 36 positioned for having its arcuate shaped lugs or tongues 80 (see FIG. 6) moved downwardly for tucking the top skin 18 ends around the arcuate or curved ends 90 (see FIG. 9) of the skateboard core 13.

It is to be understood that the procedure illustrated in FIG. 5 may be done simultaneously with the procedure illustrated in FIGS. 2, 3 and 4 by configuring the top mold 36 to include tongues 50-50 and tongues 80-80 such that when the top mold 36 moves downwardly the curved [end] tongues 80 and the generally straight, parallel tongues or lugs 50-50 simultaneously perform their functions. The procedure illustrated by FIG. 5 may be performed separately from the procedure illustrated in FIGS. 2, 3 and 4 by configuring another set of molds (separate from the set of molds in FIGS. 2-4) to accomplish the function of FIG. 5. In another embodiment, the procedure illustrated in FIG. 5 may be done before or after the procedure illustrated in FIGS. 2-4.

Embodiments of the skateboard of the present invention may also be manufactured by adhesive bonding, roller lamination or lamination with internal backer.

In roller lamination, a die cut foam sheet 18, cut slightly oversize of the top deck, is placed directly on top of a wood skateboard core 13. Together the foam 18 and wood core 13 are fed between two counter-rotating heated cylinders. The rotating cylinders compress the foam 18 to the wood deck, simultaneously pulling the foam-covered board through the rollers. The remaining foam material 18 (not bonded to the horizontal deck surface) is then wrapped around the edge 16 and end 90 of the board 13. Typically this secondary operation/procedure is done by hand wherein the foam material 18 is formed and contoured by hand (i.e. wet gloved), glued and adhered to the board edge 16. It is then trimmed to size to remove excess flash.

For roller lamination with internal backer foam 28, prior to either compression molding or roller lamination (as above), the die cut foam top skin sheet 18 is joined on its inside surface with a thin layer (i.e. 2 mm) of lower density foam 28. The external top skin foam 18 and the internal backer foam 28 are fed between two counter-rotating heated cylinders. The rotating cylinders compress the two foam layers 18 and 28 together, simultaneously pulling the two-layer sheet through the rollers, forming one thicker sheet. This two layer sheet is then bonded to the wood core 13. The benefit of an internal backer foam 28 is increased foot cushion, and improved bonding to the wood or plastic core 13, due to more porous open cell foam structure.

A preformed foam skin 18 may be glued to a structural core 13, such as by way of example, by means of a bonding agent only - - - not from lamination or compression molding. The foam skin material 18 would be previously die cut, embossed and decorated prior to adhesion with the core 13. Alternately, the foam skin material 18 can be created by pouring liquid polymer within a mold (i.e. polyurethane) creating embossed graphic details and surface texture. The molded skin is removed from the mold and stretched over a wooden blank covered with adhesive.

An alternate method of a pre-formed skin 18 can be created using an elastomeric material (i.e., silicon, synthetic rubber, or other stretchy, high-memory substrate). In this process the skin 18 is formed via a preliminary molding process such as liquid casting, injection molding, compression molding or rotational molding, whereby the formed skin 18 is subsequently removed from the mold, cooled and decorated, then stretched over the skateboard blank. It is not permanently affixed. In this application the skin 18 can be removed from the blank by the user, and replaced with an alternate skin as deemed necessary. In this application the soft top skins 18 can be replaced due to simple wear and tear, or to swap out as a fashion accessory.

For insert molding, a wooden or plastic core 13 is placed within a low temperature book-style mold. The mold is closed, and a filler apparatus injects self-skinning liquid polyurethane into the mold. After filling the mold with urethane, the core 13 is surrounded by liquid urethane on three sides only (top, bottom and sides). The mold progresses through a low temperature oven. The processing temperature and cycle time convert the urethane, forming a durable high durometer skin 18 over the top and sides of the core material only. The insert molding process can create embossed graphic details and unique surface texture.

For wood core construction, a flexible thin foam top skin 18 is bonded to a pre-formed wooden skateboard core 13. For plastic core construction, the flexible foam skin is joined to a pre-molded plastic skateboard core 13. For dual core construction, a thin molded plastic sheet is sandwiched between the foam top skin 18 and a wood core bottom. This allows for a thinner wood core with increased flex.

The top skin 18 deck surface can be decorated in a variety of ways, which include silk screen printing, pad printing, hot stamp foil, embossed artwork, foam inlays and foam lamination. The wood deck (board bottom) can be decorated by silk screen printing, multi-color heat transfer art, painting and tampon printing.

The skate board of the present invention has a number of soft top benefits. The foam-deck riding surface provides traction (without an abrasive surface), increased foot cushioning and dampens (absorbs) road and wheel vibration. The foam wrapped board edges are safer/softer when impacted in close quarter conditions. The foam-deck riding surface can be easily decorated, unlike a conventional board covered with sandpaper grip tape. The overall look is functional fashion.

By practice of various embodiments of the present invention, there are provided: (1) wrap-around foam (soft top) surface permanently secured to a skateboard core; (2) a top-cover only foam surface (soft top) permanently secured to a skateboard core; (3) removable and non-removable elastomeric (soft top) skins stretched over a skateboard core, covering top and sidewall surfaces; (4) manufacturing methods to create and assemble a permanent soft top surface; and (5) manufacturing methods to create and assemble a removable soft top surface.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any directional arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for producing a skateboard comprising the steps of:
(a) providing a deck for a skateboard;
(b) providing a skin foam sheet having a surface area greater than a surface area of the deck;
(c) bonding the skin foam sheet to the deck such as to leave a residual portion of the skin foam sheet extending beyond the surface of the deck;
(d) bonding the residual portion to the sides of the deck.

2. The method of claim 1 wherein said bonding of the residual portion comprises manually bonding the residual portion to the sides of the deck.

3. The method of claim 1 wherein said bonding of the residual portion comprises mechanically bonding the residual portion to the sides of the deck.

4. The method of claim 1 additionally comprising trimming part of the residual portion.

5. The method of claim 1 additionally comprising trimming part of the residual portion such that a remaining end of the skin foam sheet registers with a bottom surface of the deck.

6. The method of claim 1 additionally comprising bonding the residual portion to a bottom surface of the deck.

7. The method of claim 6 additionally comprising trimming part of the residual portion.

8. A method for producing a skateboard comprising the steps of:
(a) providing a deck for a skateboard;
(b) providing a skin foam sheet having a surface area greater than a surface area of the deck;
(c) providing a foam member having a surface area greater than a surface area of the deck;
(d) bonding the foam member to the deck such as to leave a residual foam-member portion of the foam member extending beyond the surface of the deck;
(e) bonding the skin foam sheet to the foam member such as to leave a residual skin portion of the skin foam sheet extending beyond the surface of the foam member and the deck;
(f) bonding the residual foam-member portion and the residual skin portion to the sides of the deck.

9. The method of claim 8 wherein said bonding of the residual foam-member portion and the residual skin portion comprises manually bonding.

10. The method of claim 8 wherein said bonding of the residual foam-member portion and the residual skin portion comprises mechanically bonding.

11. The method of claim 8 additionally comprising trimming part of the residual foam-member portion and the residual skin portion.

12. The method of claim 8 additionally comprising trimming part of the residual foam-member portion and the residual skin portion such that a remaining end of the foam member and a remaining end of the skin foam sheet registers with a bottom surface of the deck.

13. The method of claim 8 additionally comprising bonding the residual foam-member portion to a bottom surface of the deck.

14. The method of claim 13 additionally comprising trimming part of the residual foam-member portion.

15. A skateboard produced in accordance with the method of claim 1.
